(19) United States
(12) Patent Application Publication
(10) Pub. No.: US 2011/0126715 A1
(43) Pub. Date: Jun. 2, 2011

(54) CARBON DIOXIDE GAS RECOVERY APPARATUS

(76) Inventor: Takeshi KIMURA, Mito-shi (JP)

(21) Appl. No.: 12/844,142

(22) Filed: Jul. 27, 2010

(30) Foreign Application Priority Data
Nov. 30, 2009 (JP) JP 2009-271690

(51) Int. Cl. B01D 53/18

(52) U.S. Cl. 96/242; 96/266

(57) ABSTRACT

In order to improve increase of carbon dioxide gas recovery efficiency and saving costs and then to contribute to global environmental protection, in a carbon dioxide gas absorption chamber of a carbon dioxide gas recovery apparatus whose cross-section is square and in which horizontal gas flow passage is formed by providing an exhaust gas introducing opening in one side and an exhaust gas discharging opening in an opposite side thereof, a simple constitution without a support plate or a re-distributor is formed by using specific filler, in addition, a packed bed with a large surface area and a high efficiency can be formed, a negative effect due to reaction heat is lost by providing heat exchanger devices in this packed bed, absorbing ability of the carbon dioxide gas is increased by circulating the absorbing solution in the divided packed bed a plurality of times in series, corrosion resistance of the device is increased by downsizing the packed bed and the device for distributing carbon dioxide gas absorbing solution, and the concentration of the carbon dioxide gas absorbing solution is increased, so that energy-saving and reducing-costs can be achieved.

### BACKGROUND OF THE INVENTION

The present invention relates to a CO₂ (carbon dioxide) gas recovery apparatus for recovering carbon dioxide gas discharged from an electric generation plant, a cement plant, a steel plant, a petrochemical industry or the like, and its object is to contribute to global environmental protection by increasing a carbon dioxide gas recovery efficiency and reducing the cost thereof.

Until now, discharge gas treatment device were in relative small size. After that, as a flue-gas desulfurization system has been used, the device, the devices are getting larger gradually, and further, a CO₂ recovery device has been coming up recently. For recovering CO₂, Kansai Electric Power Co. Ltd. or Mitsubishi Heavy Industries group has already made chemical absorption technique using KS-1 absorbent in practical use.

This is that: after cooling discharged gas to optimal temperature for absorption, the gas is introduced into an absorption tower so that CO₂ in the discharged gas is absorbed in the absorbent to produce amine carbonates, this amine carbonate aqueous solution is transmitted into the recovery tower again, CO₂ gas is discharged by heating the solution within a range from 110° C. to 130° C. in order to return the absorbing ability of the absorbent, and discharged CO₂ gas is recovered as high concentration CO₂ after the discharge CO₂ gas is separated by a CO₂ gas separator and water content is removed from the gas, so that the device has a tendency to be come larger naturally.

If expressed concretely, the reaction is:
absorption R—NH₂+CO₂+H₂O→R—NH₃HCO₃ (absorption temperature 40-50° C.)
recovery R—NH₃HCO₃→R—NH₂+CO₂+H₂O (recovery temperature 110-130° C.)

Note that mono-ethanol monoethanolamine, kalium carbonate and the like are known as an absorbent except for the above-mentioned KS-1. In this case, if sulfurous acid gas is present in the discharged gas, because there is a possibility that CO₂ recovery is prevented by that the sulfurous acid gas and CO₂ gas absorbent are reacted and nonrenewable materials are produced, it is preferred that dust collection, desulfurization or the like are carried out in advance to the discharged gas to be treated in this case.

Furthermore, showing a reaction formula of kalium carbonate, it is:
absorption K₂CO₃+CO₂+H₂O→+2 KHCO₃ (absorption temperature 60-70° C.)
recovery 2 KHCO₃→K₂CO₃+CO₂+H₂O (recovery temperature 110-130° C.)

Besides, in use of these absorbents, advanced chemical knowledge such as use of catalysts for accelerating chemical reaction, use of corrosion inhibitors or the like is necessary.

As understood due to the above chemical formula, in the case of a chemical absorbing method for using KS-1 absorbent, though the recovery temperature can be controlled relatively lower within 110-130° C., more than one mol of alkanolamine and water is necessary to take up one mol of CO₂ gas, for instance, a large amount of absorption solution comprising more than 75 Kg alkanolamine and more than 18 Kg of water must be circulated in order to take up 44 Kg of CO₂, so that it is clear that heat energy necessary to carry out it becomes large.

Besides, the applicant proposed flue-gas desulfurization equipments disclosed in JP 53-19171 B, JP 2007-21317 A, JP 2008-12401 A, JP 4418987 B2, U.S. Pat. No. 7,527,679 and the like. These flue-gas desulfurization equipments are that a plurality of gutter-shaped lifters for piping up desulfurizing agent are attached parallel in an axial direction on an inner wall where an annular end plate having a treated gas inlet port on one end thereof and an annular end plate having outlet port on another end thereof are provided, a rotating cylinder filled with many separated filers having air gaps or holes in an inner whole space thereof is provided horizontally and rotatably, and a means for supplying desulfurizing agent is provided in one end of the rotating cylinder and an outlet of it is provided in another end thereof, so that the treated gas is contacted to the desulfurizing agent in a counter flow or in a parallel flow for gas-liquid contact.

They are that a flow of exhaust gas is leveled out and the rotating cylinder installing absorbent for desulfurization are always rotated, cost of an equipment per unit is cheaper as the equipment is larger because a plant cost is proportional only to a diameter of the rotating cylinder despite that amount of treated gas is increased in proportion to the square of its diameter. Because falling velocity of absorbent liquid is larger as the diameter thereof is larger, there are merits such that amount of absorption reaction per one flow is increased and liquid-gas ratio is decreased, and further it is possible to decrease circulation power for absorbing solution.

Besides, in a field of exhaust gas treatment where flue-gas desulfurization prevailed, a problem for separation and recovery of CO₂ has begun to attract notice gradually. Regarding separation and recovery of CO₂, various studies are also carried out in CCS Seminar in Ministry of Economy, Trade and Industry, Research Institute of Innovative Technology for the Earth or the like. For instance, a method for separating and recovering CO₂ by using physical absorptive property that amount of CO₂ dissolution into physical absorptive liquid is increased in proportion to the pressure, a method for separating and recovering CO₂ by using chemical reaction between CO₂ and absorbing solution such as an amine system or kalium carbonate are also developed.

Furthermore, a method for separating and recovering CO₂ by using solid absorption agents which are easy to absorb CO₂ and using that amount of absorption is changed at pressure or temperature, a method for separating and recovering CO₂ due to difference of boiling point of every component which is obtained by pressing and cooling treated gas to be condensed, and then by reducing pressure and evaporating, a method for separating and recovering CO₂ by using difference of gas transmission rate to a polymeric membrane, and the like are known, but final evaluation has not been obtained yet.

However, in a method for chemical absorption using KS-1 absorbent in Mitsubishi Heavy Industries' system or Toshiba' system, a standing tower calling an absorption tower or a recovery tower for a gas absorption device and a recovery device is used (see FIG. 4). Here, a system that absorbing solution flows in a downward direction and exhaust gas flows in an upward direction to the contrary is adopted. Thus, in the case that general horizontal discharge height of the exhaust gas flowing out horizontally is a certain level of height, for introducing this system to the above-mentioned absorption tower, it is necessary that an exhaust direction of the exhaust gas is changed to a downward direction until height of a lower part of the absorption tower firstly, and then the direction is changed perpendicularly, so that the exhaust gas is gotten around in approximately U-shape to communicate inside a lower part of the absorption tower.

Besides, in order to return the exhaust gas flow after discharging from the absorption tower to horizontal direction height in the inlet side original height, flow of gas discharged upward from an upper end of the absorption tower is changed perpendicularly in a horizontal direction, and then is changed perpendicularly downward, and furthermore is changed perpendicularly in a horizontal direction again at the height corresponding to the original inlet side height. Accordingly, length of an exhaust duct for returning the exhaust gas to a level height same as the inlet side height is longer as the absorption tower is higher, so that six times change of direction including three times in the inlet side and three times in the outlet side becomes necessary.

On the other hand, the absorption tower is commonly called as a packed tower, concentration of carbon dioxide in the exhaust gas treated for carbon dioxide absorption is in high concentration of 15%-20%, even if 90% of it can be absorbed, it is too much, so that the height of the packed tower becomes too high consequently. Therefore, as a size of processing equipment becomes larger, a problem becomes extremely larger, so that not only pressure loss of the exhaust gas flow becomes larger, but also it cannot be avoided that an installation space of the exhaust gas duct grows in size and treatment costs becomes remarkably large.

In addition, in order to prevent aggravation of gas-liquid contact due to separating gas route and liquid route by a drift current in a packed bed in the packed tower, as shown in FIG. 4, it becomes necessary that the packed bed is separated to a plurality of stages and absorbing solution flowing down in a packed bed in every stage is reallocated. In other words, in FIG. 4, two-four sets of re-distributors other than a distributor (two sets in FIG. 4) are necessary, remarkable appreciation of the plant cost cannot be avoided.

Besides, as considering about necessary pump head (water head difference) in this case, partial height between a support plate and the re-distributor is added in the case of separating the packed tower, and further, as an amount of treated gas becomes more, height h₁ of the absorption tower as shown in FIG. 4 becomes larger, so that there is a disadvantage that necessary power of the pump transmitting treatment liquid as it becomes larger scale.

In FIG. 4, note that height effective to absorb the exhaust gas is shown as “1”, and height only that the pump power is increased as the pump head is increased is shown as “h”. Accordingly, that a sum of h (h₁+h₂+h₃) in this case becomes larger is means that it is disadvantageous as equipment. For this matter, as shown in FIG. 5, the explanation, mainly for instance FIGS. 1 and 2 in JP 2001-520107 A indicates as it is.

Next, as considering about gas-liquid contact time in the packed bed, time of flowing down from an top of the absorption tower to a bottom of it is mere a few seconds even if the tower is made high, so that it is short as a reaction time. In addition, it is impossible to use the carbon dioxide absorption power of the absorbing solution (treatment liquid) at approximately 100%, so that it must be satisfied on some level.

Furthermore, as considering about a recovery tower, because the absorbing solution to be recovered is heated and time of discharging carbon dioxide is limited in a few seconds that the liquid flows down in the recovery tower, there is really very little possible that absorption ability of the liquid is recovered by discharging 100% of the carbon dioxide. In fact, Toshiba uses words such as “CO₂ rich” or “Lean” with a background like that. Besides, Mitsubishi heavy Industries prides that a recovery rate is high as an explanation of superiority against monoethanolamine of the aforementioned KS-1.

For instance, if an utilization rate of absorption ability of the absorbing solution in the absorption tower and a recovery rate in the recovery tower are 90% respectively, an utilization rate of absorbing solution as a whole through the absorption and the recovery becomes about 81%, so that a circulating amount of the absorbing solution is 1.23 times in comparison with the case of 100% of the recovery rate. In energy consumption of the device as a whole, heat energy for increasing temperature of the absorbing solution from low to high and power for a cooling water pump for decreasing temperature of the absorbing solution from high to low are large, so that it would be a large default that an amount of liquid circulating here is increased.

As a substantial problem of the aforementioned process, there is a quantitative relationship, as shown in the aforementioned reaction formula, between recovered carbon dioxide and monoethanolamine used as absorbing solution or a kalium carbonate, both of the monoethanolamine and the kalium carbonate are used in solution. Besides, because their corrosiveness is strong, there is a circumstance that the concentration of them cannot be increased too much. Therefore, when the device is simplified and corrosion resistance of the device is increased, because the concentration of the monoethanolamine solution or the kalium carbonate solution can be increased, a circulated amount of the absorbing solution can be decreased, so that it is possible to decrease the energy consumption largely and to downsize a recovery device.

Besides, the temperature shown in the aforementioned reaction formula is shown as a range of temperature, so that there is possibility to change the range of temperature due to performance of the absorption device and performance of the recovery device. If the absorption treatment can be carried out at higher temperature within its temperature range and the recovery treatment can be carried out at lower temperature within its temperature range, difference between both temperatures is decreased, so that energy saving can be achieved. Because potassium hydrogen carbonate (potassium bicarbonate) begins to produce carbon dioxide if temperature of it exceeds 100° C. (see “physical and chemical science dictionary”), possibility such that radiation of carbon dioxide is completed at low temperature if it takes more time becomes high.

Regarding the concentration of carbon dioxide treated in a progress for recovering carbon dioxide gas in combustion exhaust gas, the concentration is double-digit larger, at least 15-20%, in comparison with flue-gas desulfurization, and an amount of chemical reaction is larger, so that it is necessary to treat a reaction heat with the reaction. That is to say, if it is an exothermal reaction, it is effective that a cooling device for removing the heat is provided.

### SUMMARY OF THE INVENTION

Therefore, the present invention is to solve substantial problems of the aforementioned process and to enable a low cost and energy saving in all carbon dioxide gas absorption equipments from a small scale to a large scale and further to contribute a global environmental protection.

Concretely, a first invention in the present inventions relates to a carbon dioxide gas recovery device using amine system organic compound solution or kalium carbonate solution as absorbing solution, wherein the device comprises a carbon dioxide gas recovery apparatus which has a gas introducing opening in one side thereof and a gas discharge opening in an opposite side thereof in order to make a horizontal gas flow passage and whose cross-section is a square, devices for distributing absorbing solution provided at a top of the carbon dioxide gas recovery apparatus, a liquid tank installed on a bottom of the carbon dioxide gas recovery apparatus along the gas flow passage of the carbon dioxide gas recovery apparatus and a means for circulating the absorbing solution in the liquid tank in the devices for distributing the absorbing solution, wherein the carbon dioxide absorption chamber is filled with a filler for gas-liquid contact, wherein the liquid tank is divided to a plurality of sections from a first section to n-th section by a plurality of dividing walls along an exhaust gas flow direction or an opposite direction of it, wherein heat exchangers for controlling liquid temperature are provided in sections divided by the dividers respectively, wherein absorbing solution supplied at a top of the first section flows down through a packed bed and temperature of the liquid in a liquid chamber is controlled at a bottom of the first section, then the absorbing solution is supplied to a top of a second section and temperature of the absorbing solution flown down through the second section is controlled in a liquid chamber at a bottom of the second section, the absorbing solution is supplied to a top of a third section and is discharged after flowing down through the third section, thus the absorbing solution is flown in series from the first section to the n-th section as repeating the gas-liquid contact and the temperature control.

A second invention in the present inventions relates to the carbon dioxide gas recovery device according to claim 1 characterized in that the aforementioned filler for gas-liquid contact comprises a short cylindrical body having a notched portion in one side thereof or notch portions in both sides thereof, or wherein a plurality of short cylindrical bodies are arranged horizontally to make a long cylindrical shape for using. Furthermore, a third invention in the present inventions relates to a carbon dioxide gas recovery device according to claim 1 characterized in that a plurality of heat exchangers for controlling temperature are arranged along a height direction in the carbon dioxide gas recovery apparatus filled with the filler for gas-liquid contact to ensure the temperature control of the absorbing solution, thus temperature difference of the absorbing solution between an upper position and a lower position in the carbon dioxide absorption chamber is made lost.

The first invention in the present inventions is a carbon dioxide gas recovery device for using amine system organic compound solution or kalium carbonate solution as absorbing solution, wherein the device comprises a carbon dioxide gas recovery apparatus whose cross-section is square that a horizontal gas flow passage is formed by providing a gas introducing opening in one side thereof and a gas discharge opening in an opposite side thereof, devices for distributing the absorbing solution which are provided at a top of the carbon dioxide gas recovery apparatus, a liquid tank provided at a bottom of the carbon dioxide gas recovery apparatus along a direction of a gas flow passage in the carbon dioxide gas recovery apparatus, and a means for circulating absorbing solution of the liquid tank in the device for distributing absorbing solution, the carbon dioxide absorption chamber is filled with filler for gas-liquid contact, wherein the liquid tank is divided to a plurality of sections from a first to a n-th by a plurality of dividing walls along a flow direction of exhaust gas or an opposite direction thereof, wherein heat exchangers for controlling liquid temperature are installed in liquid chambers divided by the dividing walls respectively, wherein the absorbing solution supplied to a top of the first section is flown down through a packed bed and temperature of the absorbing solution is controlled in the liquid tank in the bottom of the first section, temperature of the absorbing solution supplied to a top of the second section and flowing down in the second section is controlled in the liquid tank at a bottom of the second section, the absorbing solution is supplied to a top of the third section and is flown down in the third section and then discharged, so that the absorbing solution flows in series from the first section to the n-th section as repeating gas-liquid contact and temperature control.

Because temperature of the absorbing solution is maintained at an optimal condition by the heat exchangers in the liquid chambers and the absorbing solution supplied to the first section flows and discharged in turns to the n-th section, a current such that the absorbing solution entered in first flows down and discharged in first can be maintained, so that ability for absorbing carbon dioxide gas by the absorbing solution is utilized near about 100% and there is no case that the absorbing solution is circulated to the recovery device as remaining absorption redundant ability.

Besides, because the second invention in the present inventions is that the filler for gas-liquid contact comprises a short cylindrical body having one-side notch or both-side notches, or the filler is used as a long cylindrical body consisting of a plurality of the short cylindrical bodies, the pressure loss is a little and the mechanical strength of the filler is large, so that it is not necessary to provide a special support means and it is possible to form a high packed bed. Furthermore, a hollow portion of the above-mentioned short cylindrical body is filled with small size filler whose mechanical strength is weak and whose surface area becomes relatively large, so that it is possible to increase a surface area of the filler for gas-liquid contact as a whole and thus high efficient of carbon dioxide gas recovery.

Furthermore, because the third invention in the present inventions is that the heat exchanger for controlling temperature in a plurality of stages in a height direction in the carbon dioxide gas recovery apparatus filled with the filler for gas-liquid contact, liquid temperature of the absorbing solution flowing down at every height position can be always maintained at constant even if the absorption chamber becomes high, and it is possible to increase absorption efficiency for carbon dioxide gas remarkably.

Besides, regarding a size of packed bed in this case, if the width is a, the height is h and length is 1, as a treatment quantity of the exhaust gas is proportional to a*h, if h is larger, a becomes smaller and dropping distance and time of the absorbing solution become longer, so that absorption quantity of carbon dioxide gas per once of the absorbing solution dropping can be increased. Accordingly, the number of n tends to be small and 1 tends to be short.

Consequently, area of the devices for distributing absorbing solution (a×1) becomes smaller, so that it is easy to correspond to increase of corrosion resistance of the device. Thus, concentration of the absorbent solution can be increased and liquid quantity of the absorbent solution can be decreased, so that saving energy and costs can be achieved.

### BRIEF DESCRIPTION OF THE DRAWINGS

FIG. 1 is an main section schematic longitudinal cross sectional view showing a carbon dioxide gas recovery apparatus, a renewal device and connection therebetween in a first embodiment of the present invention;

FIG. 2A is a longitudinal cross sectional view of the renewal device shown in FIG. 1, FIG. 2B is a plan view thereof, and FIG. 2C is A-A line cross sectional view;

FIG. 3 is an explanatory perspective view showing the filler using in the present invention;

FIG. 4 is a longitudinal cross sectional view showing a schematic view of the prior published packed tower; and

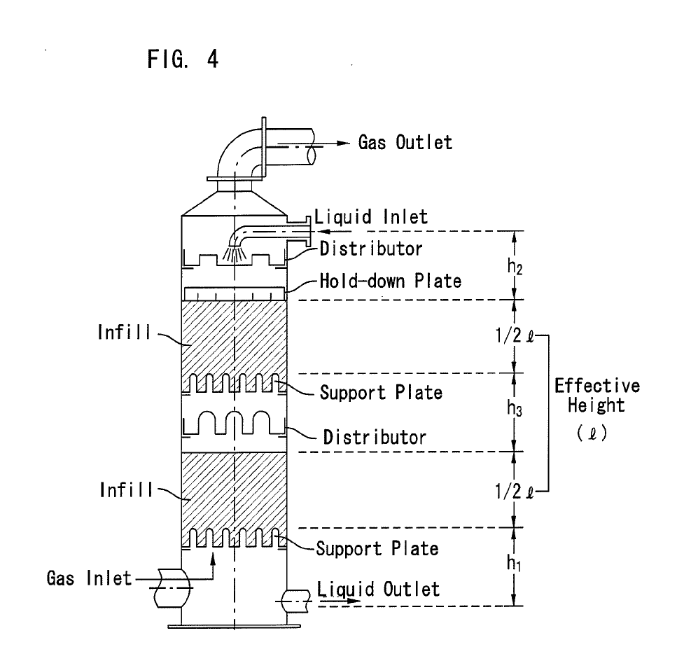

FIG. 5 is an explanatory diagram showing an outline constitution of a prior published spray tower.

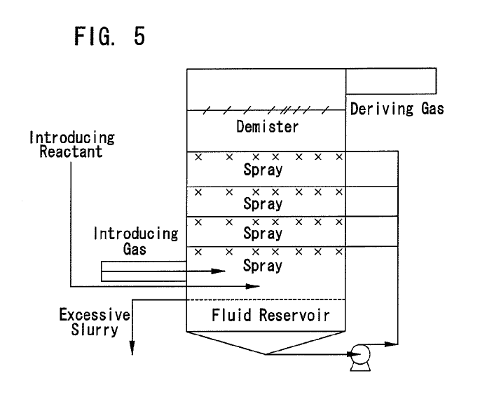

### DETAILED DESCRIPTION OF THE INVENTION

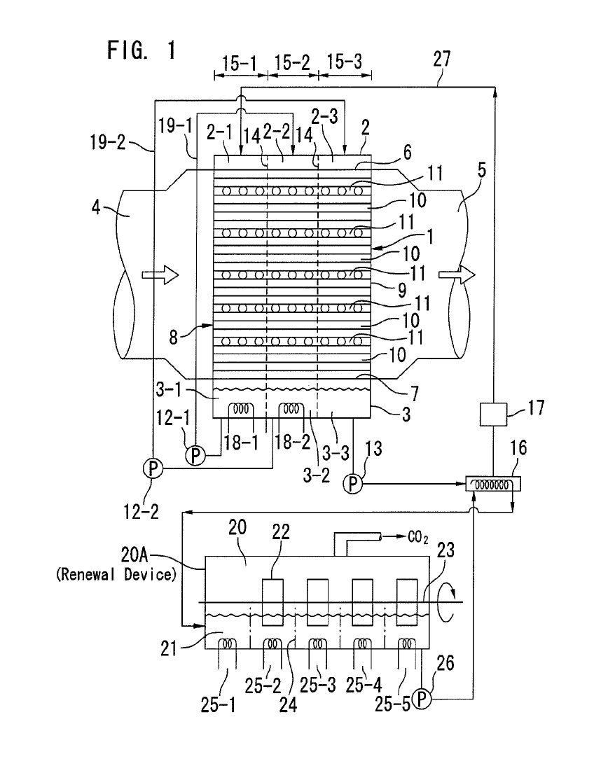

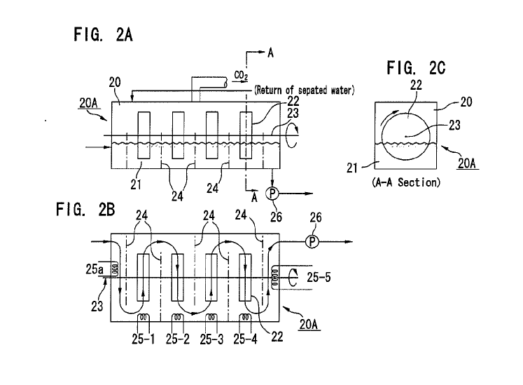

Hereinafter, preferred embodiments of the present invention will be concretely described with referent to the drawings. One of the embodiments of the present invention is shown in FIGS. 1 and 2. In this embodiment, a carbon dioxide gas recovery apparatus comprises a horizontal carbon dioxide gas absorption chamber 1, devices for distributing absorbing solution 2 provided at a top of the carbon dioxide gas absorption chamber 1 and a liquid tank 3, and further a renewal device 20A is attached thereto. The carbon dioxide gas absorption chamber 1 is formed by a space whose cross section is a square surrounded by a pair of grid-like plates 6, 7 provided up and down, a pair of grid-like plates 8, 9 provided before and behind and side walls (not shown in figures) provided right and left, and further heat exchangers 11 for controlling temperature in a plurality of stages are provided at specific intervals in a height direction thereof, and filler for gas-liquid contact 10 fills between the heat exchangers 11 of the carbon dioxide gas absorption chamber 1.

Regarding every grid-like plates 6, 7, 8, 9 for forming the above-mentioned carbon dioxide gas absorption chamber 1, it is not always for them to be formed in a grid-like constitution, for instance any constitutions other than grid-like constitution such that passage of the exhaust gas is no problem, the filler 10 for gas-liquid contact filled inside thereof is not spilled out of the carbon dioxide gas absorption chamber 1 to outside and flowing down of the carbon dioxide gas absorbing solution is not prevented, would be possible. Besides, in the figures, symbol 4 indicates a gas introducing opening and symbol 5 indicates a gas discharge opening.

Furthermore, in the figures, symbol 14 indicates partition lines provided in a vertical direction for dividing at approximately specific intervals in the carbon dioxide gas absorption chamber 1, a plurality of vertical sections are formed like a first section 15-1, a second section 15-2 and a third section 15-3 by the partition lines 14. Besides, in this case, for the aforementioned partition lines 14, it is not always to be divided by dividing walls, presence of every section like the first section 15-1, the second section 15-2 and the third section 15-3 would be able to exist ideally.

Though three sections are formed in the aforementioned embodiment, it can be expected to increase absorption efficiency of carbon dioxide gas by being more than four sections. Furthermore, the filler 10 for gas-liquid contact having a constitution (for instance described in the below embodiment), such that the carbon dioxide gas absorbing solution flowing down in every section in the carbon dioxide gas absorption chamber 1 can make liquid film form easily and gas-liquid contact becomes good, is used.

The devices 2 for distributing absorbing solution provided at a top of the carbon dioxide gas absorption chamber 1 is installed dividedly to correspond to presence of every section like devices for distributing absorbing solution 2-1, 2-2, 2-3 positioning a just above portion of every section in order to distribute the carbon dioxide gas absorbing solution supplied from the following renewal device 20A or the carbon dioxide gas absorbing solution flowing down through a specific section in the carbon dioxide gas absorption chamber 1 and supplied to a top of the other section.

Besides, for every heat exchanger 11 arranged in the carbon dioxide gas absorption chamber 1, though the heat exchanger having five stages is installed in the embodiment shown in FIG. 1, the heat exchanger is not always limited to have five stages and is changed availably due to a size and capacity of the carbon dioxide. Furthermore, the liquid tank 3 is installed along the gas flowing direction in a bottom of the carbon dioxide gas absorption chamber 1 and is divided to liquid chambers of a plurality of liquid chambers consisting of a first section 3-1 to a second section 3-2, and a n-th section 3-3 after that by a plurality of separation walls against a current direction of the exhaust gas or an opposite direction thereof (a forward direction in FIG. 1), and heat exchangers 18-1 and 18-2 for controlling liquid temperature are provided in the liquid chambers divided by the dividing walls respectively.

Furthermore, in figures, symbols 12-1, 12-2 and 13 indicate pumps for circulating and transmitting carbon dioxide gas absorbing solution, the absorbing solution supplied via a supply pipe 27 from the renewal device 20A to the device for distributing absorbing solution 2-1 is distributed in the carbon dioxide gas absorption chamber 1, the carbon dioxide gas absorbing solution flowing down through the packed bed filled with the filler 10 for gas-liquid contact into the liquid chamber 3-1 is transmitted to the device for distributing absorbing solution 2-2 via a supplying pipe 19-1 by the pump 12-1, and the carbon dioxide gas absorbing solution flowing down into the liquid chamber 3-2 is transmitted to the device for distributing absorbing solution 2-3 via a supply pipe 19-2 by the pump 12-2. Furthermore, the carbon dioxide gas absorbing solution flowing down into the liquid chamber 3-3 is transmitted to the renewal device 20A via the heat exchanger 16 by the pump 13.

In thus condition, when exhaust gas is introduced from the gas introducing opening 4 by an air blower not shown in figures, not only the exhaust gas is subject to the gas-liquid contact in a wide area during passing through the carbon dioxide gas absorption chamber 1, but also the exhaust gas moves, form left to right as shown in FIG. 1, in the carbon dioxide gas absorption chamber 1 having a certain amount of length in a horizontal direction as well as the carbon dioxide gas absorbing solution moves from left to right in turns so as to be a co-current flow aspect by each other if macroscopically, and if microscopically, gas-liquid contact is carried out in a cross current flow aspect so that the carbon dioxide gas absorbing solution moves downward in a vertical cross-sectional surface of the carbon dioxide gas absorption chamber 1 as well as the exhaust gas flows from left to right in a horizontal direction.

Accordingly, it can be expected in this case that capability and function effect which are similar to the aforementioned well-known chemical device in which the absorption towers are arranged in series to be several stages. In thus constitution, the carbon dioxide gas absorbing solution is subject to a co-current flow gas-liquid contact that is firstly intake and firstly outlet in principle with enough time in a condition that the temperature thereof is controlled availably enough to exert the absorption ability of it sufficiently, and then it is introduced into the renewal device 20A.

Besides, the renewal device 20A comprises constitution as shown in a lower part of FIG. 1 and FIG. 2. That is to say, the renewal device 20A is constituted of a carbon dioxide gas discharge chamber 20, a tank for heating carbon dioxide absorbing solution 21, rotating packed beds 22, a rotation shaft 23, flow passage restricting plates 24, heating devices 25-1-25-5, a heat exchanger 16 and a cooling device 17, and further, the flow passage restricting plates 24 are installed at constant intervals in a longitudinal direction in the carbon dioxide gas discharge chamber 20 so that one sides of the flow passage restricting plates 24 are fixed alternately to right and left wall surfaces as shown in FIG. 2B in the case of seeing it in a plan view and a flow passage of the carbon dioxide absorbing solution is formed between opposite side ends (free ends) thereof and the wall surfaces, so that flow of the carbon dioxide absorbing solution is constituted so as to wind in a longitudinal direction in the tank for heating carbon dioxide gas absorbing solution 21.

As described above, the flow of the carbon dioxide absorbing solution winds in the longitudinal direction in the tank for heating carbon dioxide gas absorbing solution 21, so that mechanism such that the carbon dioxide absorbing solution entering firstly discharges firstly is constituted, hereby it is possible to use a low temperature heat source effectively. Every rotation packed bed 22 provided every chamber divided by the flow passage restricting plates 24 in the tank for heating carbon dioxide gas absorbing solution 21 is supported by the rotation shaft 23 and rotated by a driving motor not shown in figures.

In constitution of the above-mentioned renewal device 20A, carbon dioxide gas absorbing solution used in the carbon dioxide gas absorption chamber 1 is transmitted into the carbon dioxide gas discharge chamber 20 of the renewal device 20A through the heat exchanger 16 by the pump 13, separation treatment of the carbon dioxide gas is performed effectively when it passes through the carbon dioxide gas discharge chamber 20 temperature-regulated by the heating devices 25-1-25-5, and then the treated carbon dioxide gas absorbing solution discharged from a discharge side is circulated and supplied into the device for distributing absorbing solution 2-1 via the supply pipe 27 through the heat exchanger 16 and the cooling device 17 by the pump 26.

Besides, the carbon dioxide gas absorbing solution used here is amine system organic compound solution such as monoethanolamine (alkanolamine) or carbon dioxide absorbing-recovering cycle absorbing solution such as kalium carbonate.

### [Embodiment of Filler for Gas-Liquid Contact]

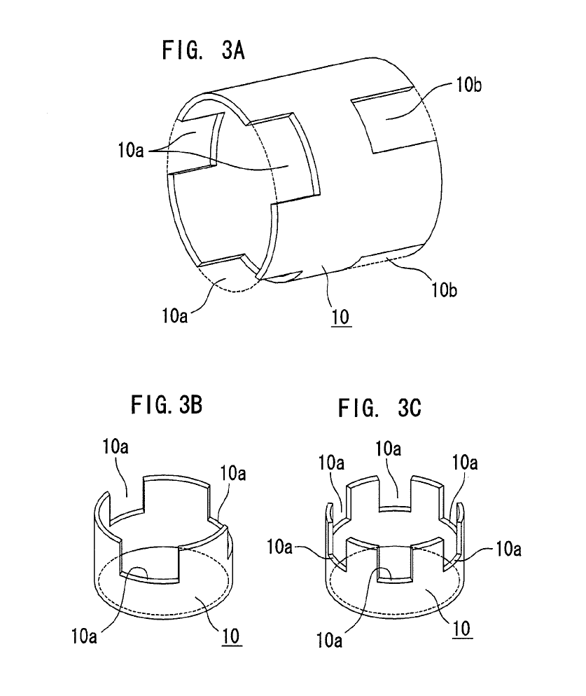

For the filler for gas-liquid contact 10 filled inside the carbon dioxide gas absorption chamber 1 in the present invention, if the filler with constitution as shown in FIGS. 3A-3C is used, because gas-liquid contact is promoted, it is further preferred. Concretely, as shown in FIG. 3A, short cylindrical bodies each of which has 90 mm in diameter, 90 mm in length and 4 mm in thickness and further three notches 10a, 10b in one side (six notches in both sides) (20 mm in notch depth and 40 mm in circumferential notch length) are connected in series in suitable number (eleven in this embodiment), or, as shown in FIG. 3B, short cylindrical bodies which has the same size of the above mentioned short cylindrical bodies and further three notches 10a in only one side are connected, or, as shown in FIG. 3C, short cylindrical bodies each of which has six notches 10a in only one side as well are connected to constitute the filler for gas-liquid contact 10 so as to be a long cylindrical body about one meter length in total.

Furthermore, if it is considered that these fill into 1 m³ of cubic capacity, one hundred and twenty-one fillers are necessary. In this case, there is a hollow portion with 82 mm in diameter and 1 m in length in the long cylindrical body. Surface area inside and outside in these cylindrical bodies is 55 m²/m³. For instance, when Tellerette (registered trademark of Tsukishima Kankyo Engineering Ltd.), which is a commercial filler, fills in the hollow portion as a plastic filler with 73 mm in outside diameter, surface area of Tellerette becomes 69 m²/m³, so that the total becomes 124 m²/m³.

Besides, in this case, when trilaminar cylindrical filler is formed by inserting a commercial Netlon Pipe (registered trademark of Mitsui Chemicals, Inc.) pipe used as water treatment with 52 mmΦ into the Netlon pipe (75 mmΦ) and including the above long cylindrical body with 55 m²/m³, the total of the surface area including the former 55 m²/m³ becomes 168.4 m²/m³ because each surface area is 53 m²/m³ and 60.5 m²/m³, so that they becomes the best numerical value. Though Tellerette and Netlon pipes used here are weak separately, the filler with the above combination can be piled up highly by being protected by the cylindrical bodies with 4 mm in thickness and the large specific surface area is obtained, so that it can contribute to much absorbing of carbon dioxide gas.

### Embodiment

Hereinafter, embodiment of the present invention will be concretely described. That is to say, when vertical cross section surface of the carbon dioxide gas absorption chamber 1 is 10 m×10 m and flow speed of the exhaust gas is 1.17 Nm/sec, as changing length of the carbon dioxide gas absorption chamber 1 corresponding to amount of absorbing carbon dioxide gas,
amount of treated gas: 420,000 Nm³/h;
   when concentration of carbon dioxide gas recovery in this case is 5%, amount of recovery carbon dioxide gas is 21,000 Nm³/h,
   weight of the carbon dioxide gas is 41.6 t/h,
   amount of carbon dioxide gas absorbing solution necessary in this case is,
in the case of monoethanolamine 57.6 t/h,
in the case of kalium carbonate 130.0 t/h,
   when the concentration of recovery carbon dioxide gas increases at 5%, 10%, 15% and 20% gradually, because all you have to do is to elongate the length of the carbon dioxide gas absorption chamber 1, the length becomes 2 m, 4 m, 6 m or 8 m.

If the effects are organized according to the above calculation:

| | concentration of | | | |
|---|---|---|---|---|
| | recovery carbon dioxide | | | |
| | gas [%] | | | |
| | 5 | 10 | 15 | 20 |
| length [m] | 2 | 4 | 6 | 8 |
| pressure loss [mm of water] | 40 | 80 | 120 | 160 |
| recovery amount of carbon dioxide gas (t/h) | 41.6 | 83.2 | 124.8 | 166.4 |
| necessary circulation amount of absorbing | | | | |
| solution [t/h] | | | | |
| in the case of monoethanolamine | 57.6 | 115.2 | 172.8 | 230.4 |
| in the case of kalium carbonate | 130.4 | 260.8 | 391.2 | 521.6 |

Furthermore, if necessary circulation amount of solution (t/h) is calculated in the case that the concentration of carbon dioxide gas absorbing solution is within a range from 10% to 40%,

### [In the Case of Monoethanolamine]

| | [recovery | | | |
|---|---|---|---|---|
| | carbon dioxide | | | |
| | gas (%)] | | | |
| [concentration of solution (%)] | 5 | 10 | 15 | 20 |
| 10 | 576 | 1152 | 1728 | 2304 |
| 20 | 288 | 576 | 864 | 1152 |
| 30 | 192 | 384 | 576 | 768 |
| 40 | 144 | 288 | 432 | 576 |

### [In the Case of Kalium Carbonate]

| | [recovery | | | |
|---|---|---|---|---|
| | carbon dioxide | | | |
| | gas (%)] | | | |
| [concentration of solution (%)] | 5 | 10 | 15 | 20 |
| 10 | 1304 | 2608 | 3912 | 5216 |
| 20 | 652 | 1304 | 1956 | 2608 |
| 30 | 432 | 868 | 1302 | 1736 |
| 40 | 326 | 652 | 978 | 1304 |

As shown in the above, in the case of monoethanolamine, also in the case of kalium carbonate, there is relationship that amount of necessary circulating solution is decreased as the concentration of the solution is increased. And thus, energy for heating the low temperature carbon dioxide gas absorbing solution and energy for cooling the high temperature recovery solution can be decreased. Though thus effort is always carried out in a field of using corrosion inhibitor, corrosion resistance of the device in this invention can be increased, and further it is improved.

That is to say, it is possible to save energy by increasing the concentration of the carbon dioxide absorbing solution to be controlled in the low level such as about 10%-20% until about 30%-40%. Thus, by scaling up corrosion resistance of the carbon dioxide gas absorption device positively, it is possible to make the concentration of the carbon dioxide gas absorbing solution more than 40%, and it is possible to decrease used amount of the circulated carbon dioxide gas absorbing solution, so that downsizing of the recovery device for absorbing solution becomes possible and further it leads to power reduction of the carbon dioxide gas absorption device.

What is claimed is:

1. A carbon dioxide gas recovery apparatus in which absorbing solution is amine system organic compound solution or kalium carbonate solution;
wherein said apparatus comprises a carbon dioxide gas recovery apparatus whose cross-section is square and in which an exhaust gas introducing opening is located in one side thereof and an exhaust gas discharging opening is located in another side thereof to form a horizontal gas flow passage, devices for distributing carbon dioxide gas absorbing solution provided at a top of said carbon dioxide gas recovery apparatus, a liquid tank installed at a bottom of said carbon dioxide gas recovery apparatus along a gas flowing direction in said carbon dioxide gas recovery apparatus and a means for circulating absorbing solution in said liquid tank to said devices for distributing carbon dioxide gas absorbing solution;
wherein said carbon dioxide gas absorption chamber comprises a packed bed filled with filler for gas-liquid contact;
wherein said liquid tank is divided to a plurality of liquid chambers consisting of a first section to a n-th section by separation walls by dividing walls in a flow direction of exhaust gas or in an opposite direction thereof;
wherein heat exchangers for controlling liquid temperature are provided in liquid chambers divided by dividing walls respectively; and
wherein the absorbing solution flows from the first section to the n-th section as repeating gas-liquid contact and temperature control so that the absorbing solution supplied to a top of the first section flows down through said packed bed, temperature of the absorbing solution is controlled in the first section liquid chamber, temperature of the absorbing solution supplied to a top of the second section and flowing down through the second section is controlled in the second section liquid chamber, the absorbing solution supplied to a top of the third section and flowing down through the third section, and then the absorbing solution is discharged.

2. A carbon dioxide gas absorption apparatus according to claim 1, wherein:
said filler for gas-liquid contact comprises a plurality of short cylindrical bodies provided with notches in one side or both sides, or a long cylindrical body formed by connecting a plurality of said short cylindrical bodies in series horizontally.

3. A carbon dioxide gas absorption apparatus according to claim 1, wherein:
a plurality of heat exchangers for controlling inside temperature are provided along a height direction in said packed bed filed with said filler for gas-liquid contact.

4. A carbon dioxide gas absorption apparatus according to claim 2, wherein:
a plurality of heat exchangers for controlling inside temperature are provided along a height direction in said packed bed filled with said filler for gas-liquid contact.

5. A carbon dioxide gas absorption apparatus according to claim 1, further comprising a renewal device for carbon dioxide gas absorbing solution, said renewal device is constituted of a carbon dioxide gas discharging chamber, a tank for heating carbon dioxide gas absorbing solution, rotation packed beds rotated and supported by a rotation shaft, flow passage restricting plates arranged so that the carbon dioxide gas absorbing solution is serpentine in said tank for heating carbon dioxide gas absorbing solution and heating devices arranged in said tank for heating carbon dioxide gas absorbing solution, and further, a heat exchanger for heat exchange between carbon dioxide gas absorbing solution transmitted from said liquid tank to said renewal device and carbon dioxide gas absorbing solution from said renewal device to said device for distributing carbon dioxide gas absorbing solution and a cooling device for cooling the carbon dioxide gas absorbing solution arranged between this heat exchanger and said device for distributing carbon dioxide gas absorbing solution.

6. A carbon dioxide gas absorption apparatus according to claim 2, further comprising a renewal device for carbon dioxide gas absorbing solution, said renewal device is constituted of a carbon dioxide gas discharging chamber, a tank for heating carbon dioxide gas absorbing solution, rotation packed beds rotated and supported by a rotation shaft, flow passage restricting plates arranged so that the carbon dioxide gas absorbing solution is serpentine in said tank for heating carbon dioxide gas absorbing solution and heating devices arranged in said tank for heating carbon dioxide gas absorbing solution, and further, a heat exchanger for heat exchange between carbon dioxide gas absorbing solution transmitted from said liquid tank to said renewal device and carbon dioxide gas absorbing solution from said renewal device to said device for distributing carbon dioxide gas absorbing solution and a cooling device for cooling the carbon dioxide gas absorbing solution arranged between this heat exchanger and said device for distributing carbon dioxide gas absorbing solution.

7. A carbon dioxide gas absorption apparatus according to claim 3, further comprising a renewal device for carbon dioxide gas absorbing solution, said renewal device is constituted of a carbon dioxide gas discharging chamber, a tank for heating carbon dioxide gas absorbing solution, rotation packed beds rotated and supported by a rotation shaft, flow passage restricting plates arranged so that the carbon dioxide gas absorbing solution is serpentine in said tank for heating carbon dioxide gas absorbing solution and heating devices arranged in said tank for heating carbon dioxide gas absorbing solution, and further, a heat exchanger for heat exchange between carbon dioxide gas absorbing solution transmitted from said liquid tank to said renewal device and carbon dioxide gas absorbing solution from said renewal device to said device for distributing carbon dioxide gas absorbing solution and a cooling device for cooling the carbon dioxide gas absorbing solution arranged between this heat exchanger and said device for distributing carbon dioxide gas absorbing solution.

8. A carbon dioxide gas absorption apparatus according to claim 4, further comprising a renewal device for carbon dioxide gas absorbing solution, said renewal device is constituted of a carbon dioxide gas discharging chamber, a tank for heating carbon dioxide gas absorbing solution, rotation packed beds rotated and supported by a rotation shaft, flow passage restricting plates arranged so that the carbon dioxide gas absorbing solution is serpentine in said tank for heating carbon dioxide gas absorbing solution and heating devices arranged in said tank for heating carbon dioxide gas absorbing solution, and further, a heat exchanger for heat exchange between carbon dioxide gas absorbing solution transmitted from said liquid tank to said renewal device and carbon dioxide gas absorbing solution from said renewal device to said device for distributing carbon dioxide gas absorbing solution and a cooling device for cooling the carbon dioxide gas absorbing solution arranged between this heat exchanger and said device for distributing carbon dioxide gas absorbing solution.
